(19) United States
(12) Patent Application Publication
(10) Pub. No.: US 2015/0178460 A1
(43) Pub. Date: Jun. 25, 2015

(54) SYSTEM, METHOD AND APPARATUS FOR SECOND OPINION

(71) Applicant: Steven James WAISBREN, Minnetonka, MN (US)

(72) Inventor: Steven James WAISBREN, Minnetonka, MN (US)

(21) Appl. No.: 14/634,543

(22) Filed: Feb. 27, 2015

Related U.S. Application Data
(63) Continuation of application No. 12/459,673, filed on Jul. 6, 2009.
Application No. 12/459,673 is a continuation of application No. PCT/US2008/000085, filed on Jan. 3, 2008.
(60) Provisional application No. 60/878,261, filed on Jan. 3, 2007.

(30) Foreign Application Priority Data
Jan. 3, 2008 (US) PCT/US2008/000085

(51) Int. Cl. G06F 19/00

(52) U.S. Cl. CPC G06F 19/3425; G06F 19/322

(57) ABSTRACT

A method for providing a medical second opinion includes receiving a first ICD-9 code from a physician at a computerized system. The first ICD-9 code is related to a clinical interest of the physician. A second ICD-9 code is received at the computerized system from a patient. The computerized system compares the first and second ICD-9 code values. By finding equivalent or equal ICD-9 codes, a physician having an appropriate clinical interest is automatically referred to the patient. The physician provides a second medical opinion.

### CROSS-REFERENCE RELATED APPLICATIONS

The present application is a Continuation of pending application Ser. No. 12/459,673 filed on Jul. 6, 2009 and entitled System, Method and Apparatus for Providing a Second Opinion the disclosure of which is herewith incorporated by reference in its entirety, which in turn is a continuation of International application number PCT/US2008/000085 having an international filing date of Jan. 3, 2008 and entitled System, Method and Apparatus for Providing a Second Opinion the disclosure of which is herewith incorporated by reference in its entirety, which claims the benefit of U.S. provisional patent application No. 60/878,261, filed Jan. 3, 2007 and entitled Method and Apparatus for Medical Second Opinion, the disclosure of which is herewith incorporated by reference in its entirety.

### FIELD OF THE INVENTION

The present invention relates to systems and methods for communication with service providers, and more particularly to systems and methods for communicating with a professional service provider.

### BACKGROUND

Recent years have seen rapid advances in medicine. Significant growth in fundamental understanding of biological processes has taken place concurrently with the development of increasingly complicated and sophisticated medical techniques and equipment. Consequently the complexity of information available to medical practitioners has increased significantly. One result of these developments has been the ability to treat increasingly complex diseases. Another result of these advances has been an increasing specialization among medical practitioners. As a result, there may be a significant disparity in the knowledge of individuals as measured between various medical practitioners.

### SUMMARY OF THE INVENTION

The inventor of the present invention has recognized that various problems are associated with the conditions described above. In particular, he has understood that wide differences exist between the experiences and capabilities of various practitioners. As a result it is often beneficial for a medical patient to have more than one medical practitioner contribute to a diagnosis. The inventor has also understood that, in light of rapid developments in communications technology, it is possible for a medical patient to benefit from the expertise of various practitioners who may be remote from one another and from the patient. It is understood that, while informal networks of referral and personal contact may give some access to remote personnel, a patient may benefit from a more formal referral system. In reviewing the existing alternatives, the inventor has understood that, while some facilities exist for remote referral of practitioners across a communications network such as, for example, the Internet, these facilities are limited, as compared to the invention described herewithin.

In light of the foregoing, the inventor has developed a system and process for providing patients access to practitioners providing medical opinions that is new and superior to those of the prior art. Accordingly, in one embodiment, the invention includes a method of referring a patient to a physician by associating an ICD-9 code provided by a patient and associated with a prior diagnosis received by the patient. In one embodiment of the invention, a data profile is prepared and associated with a particular physician, the data profile including identification of clinical interests by ICD-9 code. In one embodiment, the invention includes a system adapted to associate a request for a physician referral from a patient with a particular physician based on an ICD-9 code provided by the patient representing a prior diagnosis and an ICD-9 code provided by a physician representing an area of clinical interest.

These and other advantages and features of the invention will be more readily understood in relation to the following detailed description of the invention, which is provided in conjunction with the accompanying drawings.

### BRIEF DESCRIPTION OF THE DRAWINGS

FIG. 1 shows, in block diagram form, a portion of a communication system according to one embodiment of the invention;

FIG. 2 shows, in block diagram form, a portion of a referral system process according to one embodiment of the invention;

FIG. 3 shows, in block diagram form, a further portion of a referral system process according to one embodiment of the invention; and

FIG. 4 shows, in block diagram form, a further portion of a referral system process according to one embodiment of the invention.

### DETAILED DESCRIPTION

The following description is provided to enable any person skilled in the art to make and use the disclosed inventions and sets forth the best modes presently contemplated by the inventor of carrying out his inventions. In the following description, for purposes of explanation, numerous specific details are set forth in order to provide a thorough understanding of the present invention. It will be apparent, however, to a creative practitioner of ordinary skill in the art that the present invention may be practiced without these specific details. In other instances, well-known structures and devices are shown in block diagram form in order to avoid unnecessarily obscuring the present inventions.

The present invention includes systems methods and apparatus for facilitating a communication of information, such as medical information, between a service provider, such as a physician and a service consumer, such as a patient. In a particular embodiment, the system is adapted to receive a plurality of items of information from a physician. In certain embodiments, this information is stored in a machine-readable memory device. According to certain embodiment, this information is automatically coordinated with patient information by an automatic device such as a digital computer. In certain embodiments, the digital computer reads the machine readable memory device.

Among the plurality of items of information is an identification code, such as, for example, an International Classification of Diseases 9 (ICD-9) code, identifying an area of clinical interest, or special knowledge possessed by the physician. The system is adapted to receive a plurality of items of information from a patient, the items of information including at least one further identification code, such as, for example, an ICD-9 code. A relationship is identified between an information code received from the patient and information code received from the physician, and this relationship is used to coordinate a communication between the patient and the physician. In one exemplary embodiment, a physician is automatically selected to provide information to a patient based on an equality relation between an ICD-9 code provided by the physician and a further ICD-9 code provided by the patient.

In one embodiment of the invention, an evaluation of a relationship between an ICD-9 code provided by a physician and a further ICD-9 code provided by a patient is conducted by an automatic evaluation device. In one embodiment of the invention, the automatic evaluation device is a computer device, wherein the automatic evaluation device is coupled to a communications network such as, for example, the Internet.

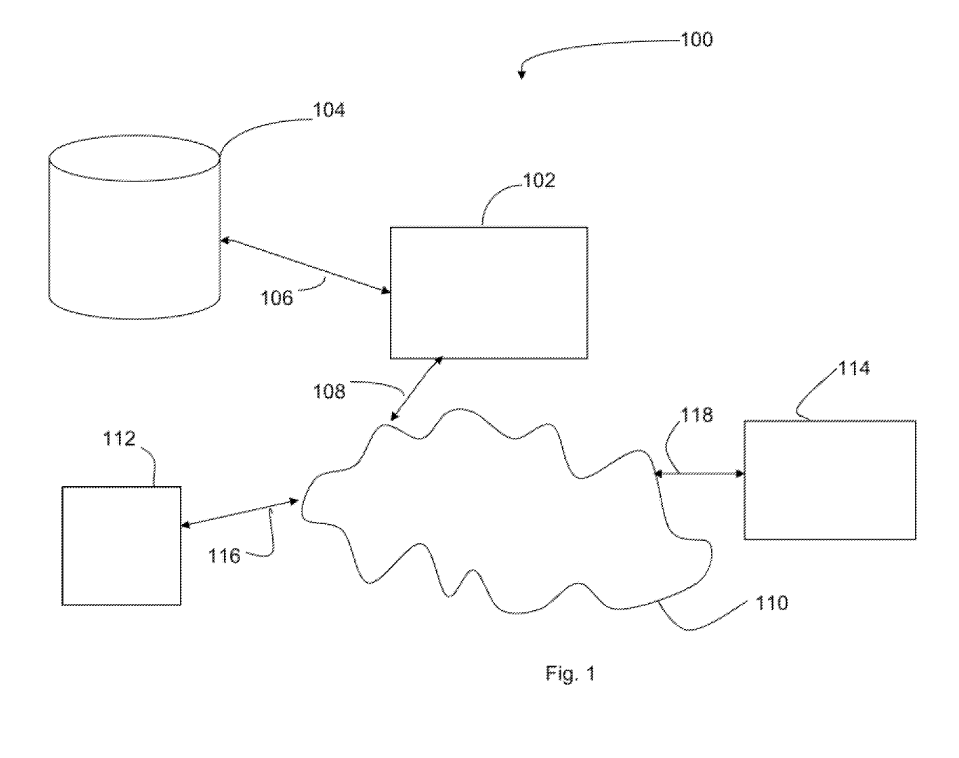

In view of the foregoing, FIG. 1 shows, in block diagram form, a portion of one embodiment 100 of the invention including an evaluation device 102. In the illustrated embodiment, the evaluation device is considered to be an automatic digital computer. This evaluation device is merely exemplary of many possible devices such as exist or maybe developed which are capable of performing the activities requisite to the invention, as further described below.

In one embodiment, the evaluation device 102 includes, or is coupled to, a data storage device 104. In one embodiment, the data storage device includes a computer readable medium. According to one embodiment the data storage device 104 includes a disk drive. In a further embodiment, the data storage device 104 includes a semiconductor memory device. In still another embodiment of the invention, the data storage device 104 includes an optical storage device, or other storage device as known in the art. A signaling interface 106 between the evaluation device 102 and the data storage device 104 allows an exchange of information between the evaluation device 102 in the data storage device 104.

Evaluation device 102 is also connected through a communications interface 108 to a communications network 110. According to one embodiment of the invention, the communications network 110 includes both hardware and software communications components. According to one embodiment of the invention the communications network 110 includes a portion of the Internet. In one embodiment of the invention, the communications network 110 is adapted to transfer signals representing information between evaluation device 102 and a remote device.

According to the illustrated embodiment of the invention, the communications network 110 is coupled to first 112 and second 114 communications devices through respective communications interfaces 116, 118. In various embodiments, the communications devices 112, 114 include user input and user output devices. According to one embodiment, communication device 112 is a personal computer and includes a keyboard, a mouse and a display screen. In other embodiments, the communication devices 112, 114 include any of a wide variety of devices adapted to communicate with a remote device through a communication network. For example, the communication devices 112, 114 include, in various examples, laptop computers, cellular telephones, personal digital assistants (PDAs), wired telephone devices, and other communication devices.

According to one embodiment of the invention communication device 112 is adapted to receive an item of information from a patient and to provide a further item of information to the patient. In a further embodiment of the invention, communication device 114 is adapted to receive still a further item of information from a physician, and provide yet another item of information to the physician. According to one embodiment of the invention, these items of information are stored for subsequent retrieval in the computer readable medium of data storage device 104.

According to one embodiment, communication devices 112, 114 are adapted to receive manually entered information and display textual and graphic information. In other embodiment of the invention, communication devices 112, 114, are adapted to receive and convey information stored in computer readable form. For example in one embodiment of the invention, communication device 112 is adapted to receive data representing a digital image. In another embodiment of the invention, communication device 112 is adapted to receive data such as, for example, numeric data, representing a test result.

According to one embodiment, a method according to the invention is adapted to provide an answer to a patient in relation to a question about the patients health. In one embodiment, this is achieved by connecting the patient to a medical specialist over the internet. According to one embodiment of the invention, this connection is made automatically by evaluation device 102. According to one embodiment of the invention, the answer provided according to the present invention is adapted to supplement a previously presented answer provided by, for example, another physician (e.g., a primary care provider or other specialist). According to one embodiment of the invention, communications between the patient and the second opinion provider takes place via electronic mail using the internet.

In one embodiment of the invention, communication device 112 is disposed in relative proximity to communication device 114. For example in one embodiment of the invention communication devices 112 and 114 are disposed within a single building. In another embodiment of the invention, communication devices 112 and 114 are disposed relatively remote from one another. In one embodiment, communication devices 112 and 114 are disposed in different countries and in one embodiment of the invention in geographically distant regions of the world. One of skill in the art will appreciate that, in various embodiments, devices 112 and 114 are merely representative of a large number of communication devices adapted to be coupled to a communications network 110.

According to one embodiment of the invention, communication devices 112, 114 are adapted to be used by first and second physicians respectively. Therefore, in one embodiment, the invention includes physician-to-physician second opinions both within the United States and internationally. In certain embodiments, further communications are facilitated automatically by evaluation device 102 reading machine-readable storage device 104.

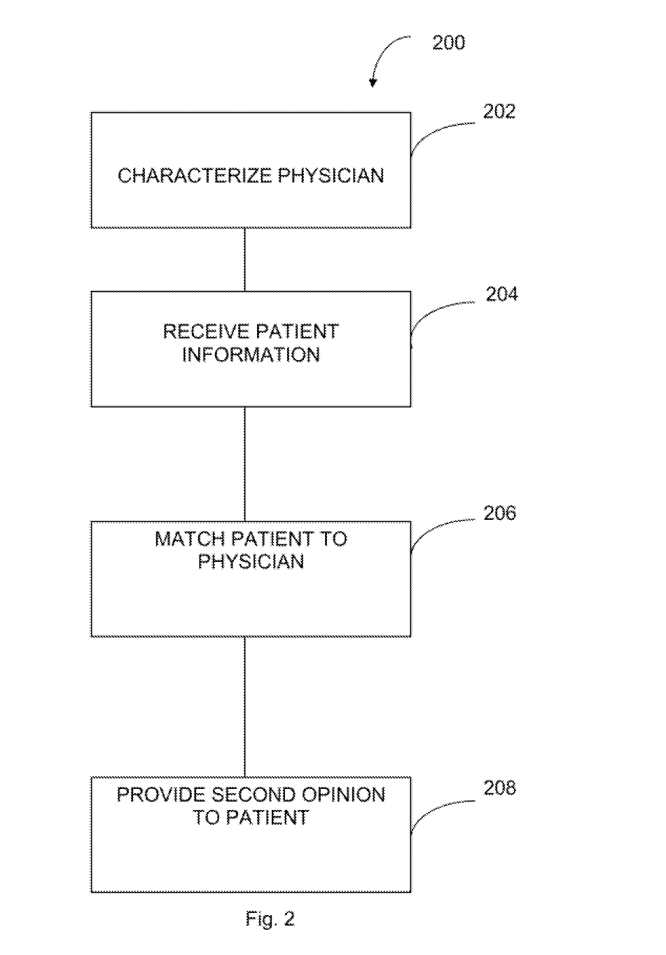

FIG. 2 shows, in block diagram form, a portion of a process 200 according to one embodiment of the invention. According to the illustrated embodiment, the process 200 includes a first step 202 in which a first physician is characterized. As will be discussed in additional detail below, the step of characterizing the first physician 202 includes, in various embodiments, automatically collecting information about the first physician from the first physician, and collecting information about the first physician from other sources. According to one embodiment of the invention, the step of characterizing the first physician 202 includes the step of receiving from the first physician data including one or more ICD-9 codes representing respective areas of clinical interest of the first physician.

The process 200 also includes a step of receiving patient information 204. As will be discussed in additional detail below, in one embodiment, the step of receiving patient information includes automatically receiving from a patient data including one or more ICD-9 codes. According to one embodiment of the invention, the one or more ICD-9 codes received from the patient represent a clinical diagnosis of a condition of the patient. According to one embodiment of the invention, the patient receives the one or more ICD-9 codes from a further physician. In one embodiment of the invention, the further physician is a physician who has been in physical proximity to the patient and has conducted a physical examination of the patient.

The process 200 also includes a step of matching the patient to the first physician 206. As will be discussed in additional detail below, the step of matching the patient to the first physician 206 includes, in one embodiment, automatically matching an ICD-9 code provided by the patient to an ICD-9 code provided by the first physician using the evaluation device 102 of FIG. 1.

In a further step, process 200 includes the step of providing a second opinion to the patient 208. As will be discussed below in additional detail, step 208 includes, in various embodiments, providing a communication to the first physician, the communication including further information related to a condition of the patient and providing information representing further diagnosis from the first physician to the patient. According to one embodiment of the invention, step 208 includes having the further physician receive the further diagnosis from the first physician. In one embodiment, this further communication takes place automatically and involves the reading of machine-readable storage device 104 by evaluation device 102.

In various embodiments, step 208 includes the transmission of X-ray images to off-site radiologists. In various embodiments, pathological specimens are viewed from a distance using digital cameras linked to a microscope in a pathologist's offices. Other embodiments include the provision of virtual assistance during surgery.

Arthroscopic operations are substantially all performed using video signals and, in various embodiments, step 208 includes a provision of a second opinion by connecting the intra-operative video camera to a distant orthopedic surgeon. In still further embodiments, insurance companies determining appropriateness of care, law offices reviewing malpractice cases, and workmen's compensation firms reviewing injury claims receive information as part of step 208.

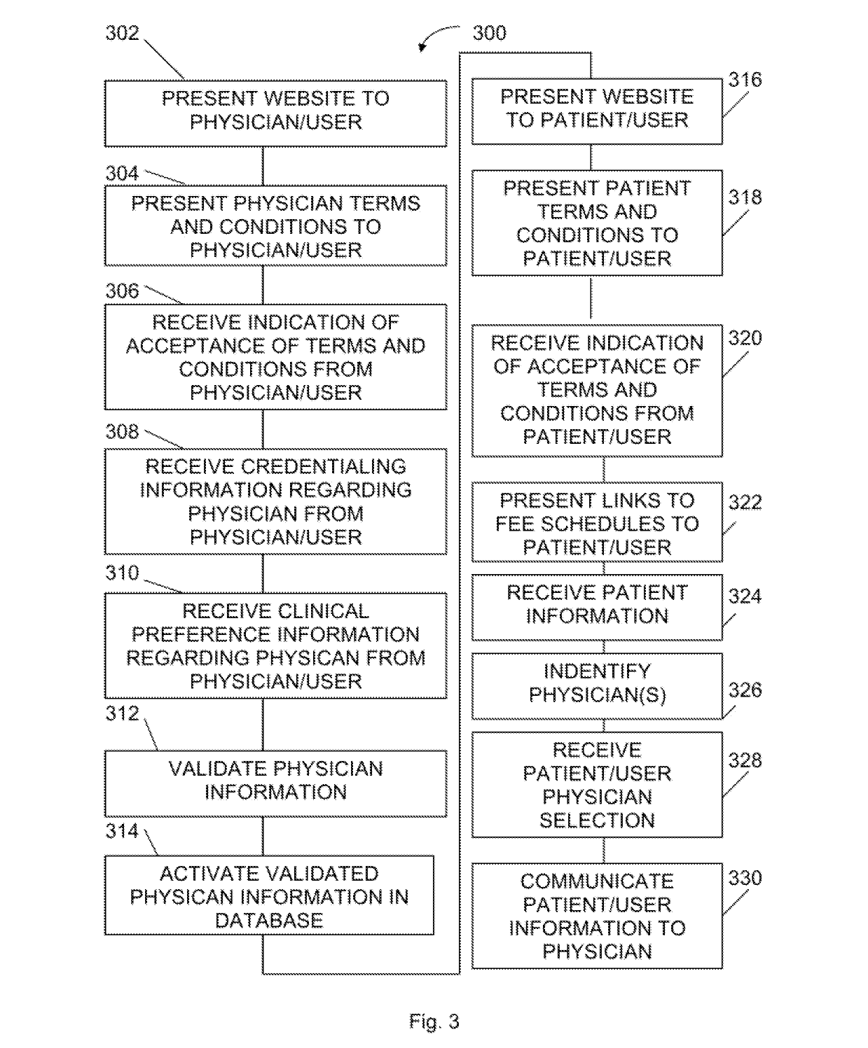

FIG. 3 shows, in various aspects, a portion of a process 300 according to one embodiment of the invention. According to the illustrated embodiment, a website is communicated over the Internet. One of skill in the art will appreciate, however, that while the Internet is now substantially ubiquitous and therefore a desirable means of communication, other means of communications are available now and will be available in the future, and could be employed in the context of the present invention.

In the illustrated embodiment, a website is prepared and presented for communication, in various aspects, to doctors and patients. As a result of these communications, a patient having, for example a first diagnosis, is placed in communication with an appropriate physician. The physician provides a second opinion which is communicated back to the patient. As part of this process, the physician is received and validated as a qualified physician and the patient is received and enabled to provide information related to the first diagnosis. In various embodiments, this process takes place automatically under the control of evaluation device 102.

It will be understood that while a physician may directly enter information into a website, the physician may also, according some embodiments, delegate an agent to enter information into the website. In like fashion, a patient can delegate an agent to communicate with the system. Accordingly, references herein to physician and patient, as well as references to user, are to be understood to include references to an agent of a physician, patient or other user.

As discussed above in relation to step 202 of FIG. 2, one embodiment of the present invention includes characterizing a physician. Thus process 300 includes step 302 in which a page of a website is presented to a physician. On the same or a further page of the website, or of an ancillary website, terms and conditions related to participation of the physician in the system of the invention are described 304.

According to the illustrated embodiment, the system must receive an indication of the physician's agreement to the terms and conditions in order for the process to proceed. One of skill in the art will appreciate that agreement to terms and conditions can, in one embodiment, be confirmed by an action such as a Web click at a website. In another embodiment, the system is adapted to print a printed form. The physician executes the printed form indicating agreement to the terms and conditions, and the physician communicates the sign form to a representative of the system by electronic mail, fax, postal mail, courier, or other communication medium as known in the art. Accordingly, in step 304, the system receives indication of acceptance of terms and conditions from the physician. In certain embodiment, this indication is stored in machine-readable storage medium 104.

In step 308, the system receives credentialing information regarding the physician. In various aspects, according to one embodiment, information is received directly from the physician by input to the website, directly from the physician by alternative means such as submission of documents, indirectly from alternative parties such as certification entities by way of the physician, and/or directly from certification entities and other parties, by way of electronic and other communication means.

According to various embodiments, physicians in the system will be credentialed. Insurance companies, HMO's, and hospitals all credential their providers. These same criteria will be used for physicians according to various embodiments of the present invention. These data, with accredited verification, is readily available on-line from the American Medical Association. Criteria will include valid licensure, confirmation of training, and review of malpractice/legal claims against the physician.

In various embodiments the physicians validated and qualified by the system will be all be licensed specialists from the United States. In one embodiment, specialties represented will include—but not be limited to—cardiology, cardio thoracic surgery, gastroenterology, genetics, gerontology, infectious disease, internal medicine, neurology, neurosurgery, nutrition, obstetrics/gynecology, oncology, orthopedic surgery, otolaryngology, pediatrics, physical medicine and rehabilitation, plastic surgery, and psychiatry. According to one embodiment when a physician registers with the system, that physician will list his or her areas of expertise and his or her particular clinical interests. This information will help triage the patient to the appropriate practitioners. In various embodiments, this triaging process takes place in whole or in part under the control of the evaluation device.

In step 310, the system receives clinical preference information regarding the physician from the physician. In one embodiment, clinical preference information is received in the form of an electronic selection at a website. According to one embodiment of the invention, the physician checks a checkbox on a website webpage to indicate a clinical preference. Clinical preference is understood to mean an area of practice in which the physician has experience and/or desires to practice and/or has particular expertise. As discussed above, in one embodiment, clinical preference information is indicated by selection and/or entry or other communication of one or more ICD-9 codes.

In step 312, the exemplary illustrated system performs a validation of physician information. According to one embodiment of the invention, validation of the physician information includes review of credentialing information received in relation to step 308 by a qualified reviewer. A qualified reviewer is, in one embodiment, a person having legal and/or medical knowledge appropriate to distinguish the appropriateness of the physician for a particular practice. The validation process includes a broad validation as to the general qualification to practice. According to various embodiments, the validation process also includes a review of clinical preference information received at step 310, and correlation of qualification information to indicated clinical preference information.

Based on the results of validation process step 312, a physician is determined to be qualified or non-qualified for particular medical opinion activities. According to one embodiment of the invention, a data store is prepared relating the qualifications of the physician to an identity data value of the physician. In one embodiment of the invention, qualifications of the physician made with respect to the identity data value of the physician are indicated by storage of an ICD-9 code. It should be understood that the ICD-9 code may be represented in any format, as known in the art, and may be stored in, for example, a machine-readable code.

According to one embodiment of the invention, the validation process of step 312 is repeated periodically and/or in response to an input such as any input that might raise question as to current physician status. In one embodiment of the invention, data sources such as, for example, certification board or other certification authorities, employers, patients, and other information providers, are regularly polled as part of a certification or recertification process.

Upon completion of a validation process that results in affirmative validation, i.e., qualification, of a particular physician the physician is indicated to be active within the system. An active physician is, in one aspect of the invention, available to receive referrals and to provide opinions. Thus in exemplary step 314, a physician is activated and information related to the physician becomes available to the system. In various embodiments of the invention, any or all of the information received in the foregoing steps of process 300 are stored in a database of information, as represented, for example, as data storage device 104 of FIG. 1.

Steps 316-330 of process 300 are to be understood, in one embodiment, to correspond to step 204 of FIG. 2 in which patient information is received. Accordingly, in step 316 a website is presented to a patient. According to one embodiment of the invention a purpose of the website is described to a patient at a first webpage (i.e., a homepage) of the website. As discussed above with respect to the physician, alternative means of presentations are encompassed in the present description and any appropriate means may be employed for the transfer of information from the patient to the system 300.

In one embodiment a webpage of the website presented to the user in step 316 includes introductory information describing a second opinion process of the present invention. Accordingly, the presentation of terms and conditions indicated at step 318 may take place on a first website, or on a subsequent webpage of the invention. It should be understood that the terms and conditions presented to the patient are, in most embodiments, different from the terms and conditions presented to the physician at step 304. In like fashion, the initial web page presented at step 316 is generally different from the initial webpage presented at step 302. Nevertheless, in some embodiments, a common webpage is presented to both the physician and the patient at steps 302 and 316 respectively. As would be understood by one of skill in the art, in such an embodiment, a physician and a patient would be presented with alternative selection options resulting in the subsequent display of different webpages. According to certain embodiments, the physician terms and condition webpages referred to in step 304 are unavailable to the general public.

In step 320, according to the illustrated embodiment, the system receives an indication from the patient of agreement to the terms and conditions presented with respect to step 318. As discussed above with respect to the physician in relation to step 306, agreement by the patient to the terms and conditions, may be indicated by any appropriate method including, without limitation, Web click, submission of an executed document, or other method or combination thereof.

According to some embodiments of the invention, a webpage is presented to the patient including information related to fee schedules. In certain embodiments, an opportunity is presented for a patient to enter insurance information. In a further embodiment of the invention and opportunity is presented for a patient to enter credit card, bank transfer, or other payment information. In certain embodiments of the invention, prepayment, including for example prepayment by delivery of a check, is contemplated.

At step 324, patient information is received by the system from the patient. Again, the receipt of patient data may take place electronically by direct entry into a webpage, or may be received from the patient directly by other means such as postal correspondence, courier, etc. In still other embodiments, patient information is received indirectly from third parties including physicians, medical records management organizations, insurance providers and others, and combinations of the same. It should be understood that among the information received, the system may receive ICD-9 codes in certain embodiments.

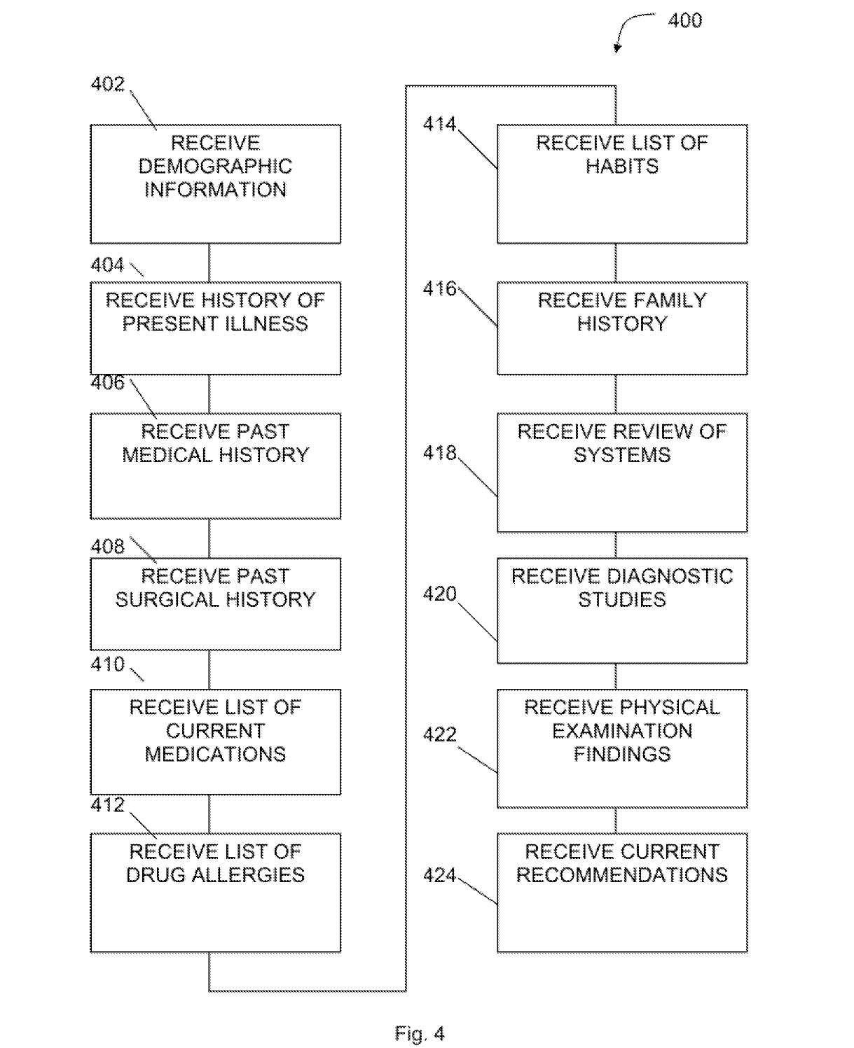

According to certain embodiments, a patient is asked to provide a pending diagnosis or procedure that is contemplated. As will be described in additional detail below, the patient will be directed by the search engine to a choice of medical specialists to choose. In certain embodiments, links are provided to a description of each provider's qualifications and clinical interests. In alternative embodiments or circumstances, as discussed below a patient is assisted in physician selection by a triage nurse. The receipt of patient information is discussed below in additional detail with respect to FIG. 4.

Based on information received at step 324, including in some embodiments one or more ICD-9 codes, the system 300 identifies an appropriate validated physician to provide a further opinion and/or diagnosis 326. In various embodiments, the correlation of patient and physician includes operation of a search engine. In certain embodiments the correlation of patient and physician includes the operation of a secure database management system.

At step 328, according to certain embodiments of the invention, identification information related to the selected physician is communicated to the patient, and at step 330, patient information is communicated to the selected physician. It should be understood that in some embodiments more than one physician is identified at step 326, and that ultimate completion of the process of rendering an opinion and/or further diagnosis is completed subsequent to selection of one of the one or more physicians by the patient.

In other embodiments, the system is adapted to receive an expression of interest from one of the plurality of selected physicians. In still other embodiments, a plurality of opinions and/or further diagnoses is received by the patient from a plurality of physicians. In still another embodiment of the invention, a plurality of selected physicians cooperate in the production of a further opinion and/or further diagnosis.

According to one embodiment of the invention, a physician will check in daily with the system of the invention to see if any patient histories are waiting to be reviewed. According to certain embodiments, patient records will be reviewed in the order received. Also according to certain embodiments, if a chart is incorrectly triaged to the wrong physician or specialty, the receiving physician will redirect it to the appropriate specialist.

In certain embodiments, the physician will review a patient record and write an e-mail to the patient. A copy of the opinion produced (e.g., the e-mail) will be retained by the system. In certain embodiments, the physician will provide one or more appropriate CPT codes to the system for use in preparing a patient bill. In certain embodiments, the patient credit card will be directly billed for the fee. In some embodiments, the physician will be paid after payment is received from the patient or an alternative responsible party such as, for example, an insurance provider.

In various embodiments, communications between physicians and patients and between physicians and other physicians take place by means of pre-existing electronic mail systems. In other embodiments, the invention includes communications facilities, including, for example, secure communications facilities. In some embodiments such communication facilities are integral to, for example, a website. In some embodiments, communications facilities include teleconferencing and videoconferencing communication facilities. In other embodiments, the communications facilities include text messaging facilities and chat facilities. In still other embodiments any appropriate communication facilities, as known in the art, may be incorporated into the system of the invention.

In certain embodiments patients will find the web page for the system of the invention over the internet. In some of these embodiments, the webpage of the invention is available by operation of a search engine such as, for example, the Google® search engine. According to certain embodiments of the invention Communication between the second opinion physicians and the patients follow American Medical Association Guidelines (www.ama-assn.org/ama1/x-ama/upload/mm/368/consultations.pdf).

In certain embodiments, patients will first determine what diagnosis or symptom they have. They may obtain this diagnoses and/or symptoms from their primary physician. In certain embodiments, this diagnosis and/or symptoms is characterized by the use of ICD-9 codes.

According to certain embodiments, as discussed above, the search engine, of the system will then suggest appropriate specialists. Also as discussed above, the patient is, in certain embodiments, enabled to select a particular physician from a list provided by the system. In one embodiment, this list is linked to the database on these physicians' professional qualifications. Information on the doctors' medical schools, residency and specialty training would be described as well and any particular clinical interests they have will be delineated. According to various embodiments, feedback from other users, including for example other patients, is included in the information on the physician.

According to a particular embodiment, if the patient is not sure of which doctor or specialty to choose, a human triage nurse receives, examines, and forwards the patient's medical information to an appropriate physician. In certain embodiments, the triage nurse will have access to this same database as well as a search engine to assist the patient in finding the appropriate specialist.

According to one embodiment, the patient will then be asked to provide medical history information. As discussed above, a patient may wish to use an on-line medical records company to forward their medical information to the system, or may prefer to fill out an on-line form supplied by the system and presented, for example, on a webpage.

In certain embodiments, the completeness of the data set required to be entered will depend on the complexity of the medical problem. First the patient will need to describe their specific question or reason for the second opinion. For relatively simple medical problems, not all of these data will be necessary or pertinent to the patient's primary problem and, in some embodiments, the system may allow the patient, and the patient may decide to, leave certain fields blank.

FIG. 4 shows, in additional detail, a portion of a process of receiving patient information 400. As discussed above, depending on the particular answers provided by a patient to certain questions, other further information may or may not be required. Information may be received by the presentation of menus, checkboxes, radio buttons, text entry, icon selection, e-mail, paper mail, and any other appropriate means. Thus, in one embodiment, demographic information is received into the system from the patient 402. Examples of demographic information, according to some embodiments, include such information as name, address, age, and in some cases Social Security number. According to some embodiments, identification is not provided and the patient is able to provide and receive information, opinions and diagnoses anonymously.

In a further step 404, information related to the present illness is received. In certain embodiments, detailed history information includes the patient's particular symptoms and signs of disease. Additional pertinent medical information may include recent illnesses and hospitalizations.

In a further step medical history information, as would be understood by one of skill in the art, is received 406. Additional patient information received into the system includes, in various embodiments, past surgical history 408, such as, for example, complications from anesthesia or bleeding, and a list of current medications 410. In some embodiments, the patient provides authorization to a pharmacy or other record keeper to provide records relating to current medications. In certain embodiments generic drug names are received. In other embodiments, proprietary drug names can be received.

In certain embodiments, further patient information received in the system includes information related to drug allergies 412, information related to personal habits including, for example, diet, alcohol consumption, cigarette use and street drug abuse.

Further information collected in various embodiments includes family history 416, a review of symptoms (e.g., pulmonary, cardiac, etc.) 418 and diagnostic studies including x-rays and laboratory reports 420. As is known in the art, various diagnostic studies and laboratory reports are readily received in the form of digital data transmissions.

Also in various embodiments, the patient may enter or authorize others to enter information related to physical examination findings 422 and current recommendations by, for example, a primary physician 424.

According to certain embodiments of the invention, communication with physicians is conducted by e-mail. Physicians will, for example, be expected to check their email daily to determine if there are consultations waiting to be reviewed. Physicians will be expected to write their second opinions in a maximum of three days. The subject practitioner may, in some embodiments, request additional information from the patient.

According to certain embodiments, the format for an opinion will follow standard physician charting style. The information provided will conform to the format a physician would write in a patient medical record. For example, the physician will write a brief narrative about the disease, give his or her clinical assessment of the patient's problems, and then provide specific advice to the patient. According to certain embodiments of the invention, a physician will be prohibited from prescribing medicine or ordering specific tests themselves.

The physician will then give an opinion as to reasonableness of the primary physicians' plans. The second opinion physician may agree with the primary physician or suggest that the patient discuss with the primary physician another form of treatment. Most likely, the second opinion physician will elaborate on the relative risks and benefits of proposed treatments made by the primary health care provider and suggest the relative merits of other treatments. They may also give suggestions to alternative diagnoses and other diagnostic tests that should be ordered. Depending on the nature of the second opinion consultation, the patient may wish to print out the recommendations to give to their primary physician or simply use their new-found information to better discuss their care with their primary physicians.

In certain embodiments, the system may provide facilities for the physician rendering the second opinion to refer the patient to another provider in their community if, for example, the patient so requests. In other embodiments, the physician may make such a recommendation by direct communication. The physician may also suggest links to more general sources of information available over the internet. In certain embodiments, the system will provide links to each specialist within the system.

According to one exemplary embodiment, when a physician registers with the system, that physician will be asked specific questions about their clinical interests. The physician will be able to list, for example, ten specific interests. As discussed above, these clinical inquiries will be very specific and use the same terminology as those in the International Classification of Diseases 9 codes (ICD9) [American Medical Association] codes. These ICD9 codes are numbers that refer to specific diseases or symptoms. When physicians or patients submit a claim to an insurance company, they have to list the ICD9 code along with their CPT code (see below for more on CPT codes). Physicians are already familiar with these codes. Physicians may wish to review their billing records to see what clinical entities they treat most commonly.

Thus, the patient will enter their specific diagnosis or symptom. The search engine will then match that diagnosis to the physician that listed it as one of their clinical interests. These clinical interests will be much more specific than specialties. For instance, all otolaryngologists may treat nasal polyps, but those otolaryngologists who specifically list nasal polyps as interests will be selected first with the search engine. These interests may also be listed by therapy. For example, the patient may wish to have his hernia repaired using laparoscopic rather than open surgical techniques. Thus, the surgeon will list his clinical interest as laparoscopic surgery and use CPT codes for laparoscopic hernia repair. Thus, only those general surgeons who actually perform this laparoscopic repair will be matched to the patient seeking advice on laparoscopic hernia repair. In this way the search engine can search for diagnosis (based on ICD9 codes) and procedures (based on CPT codes).

By using the clinical and therapeutic interests of the physicians, the search engine will help select the appropriate doctor more accurately than just by matching by specialty. Furthermore, not all patients know what specialty is most appropriate for their problem. Many patients would not know if a urologist, nephrologist, vascular surgeon, internist, or cardiologist would be the best doctor to consult with on a problem of hypertension caused by arteriosclerosis of the renal artery. Also, for some problems more than one specialist would be appropriate. For instance, many orthopedic surgeons, plastic surgeons, and general surgeons operate on patients with carpal tunnel syndrome. In this case, any of these specialists would be an appropriate choice.

Additionally, the use of the ICD9 codes for diagnosis names would be very helpful for patients seeking articles from the literature on those subjects. Thus, this technique of referring all clinical problems to these codes would standardize the distribution of medical literature to patients and doctors. Patients would have to know only their ICD-9 code or CPT code to find appropriate information on their disease using these literature searches.

The other important reason to use ICD-9 codes is that these diagnosis codes are submitted for US third party (i.e. insurance company) billing. As will be explained later, once the ICD-9 code is determined, the specialist will just need to determine the appropriate level of service in an evaluation and management code (E & M) to have a bill ready to be sent for payment.

According to certain embodiments, charges for the service of the invention will follow the same coding pattern that physicians currently use. These are all based on the billing system called CPT (Current Procedural Terminology) and Evaluation and Management sponsored by the federal government Health Care Financing Administration and the American Medical Association.

It should be noted that this method of setting payments is used by all U.S. insurance companies and the federal government. Physicians are very familiar with this system. Seven components are recognized in determining the fee: history, examination, medical decision making, counseling, coordination of care, nature of presenting problem, and time. Because no physical examinations will be performed, the highest levels of service will usually not be used—unless the problem requires an extraordinary amount of time. Thus, most second opinion consultations will be in the middle range of the fee spectrum. Listed below are exemplary average charges for medical consultations and corresponding codes.

99241--self limited or minor presenting problems
a problem focused history
straightforward medical decision making
$99
99242--low to moderate severity problems
an expanded problem focused history
straightforward medical decision making
$141
99243--moderate severity of presenting problems
a detailed history
medical decision making of low complexity
$183
99244--presenting problems of moderate to high severity
comprehensive history
medical decision making of moderate complexity
$245
99245--presenting problems of moderate to high severity
comprehensive history
medical decision making of high complexity
$320

Unlike the experience patients have at most physicians' offices, according to one embodiment, the criteria for these codes will be readily available for the patients to review prior to having their second opinion consultation.

Initially, for example, the physician's fees will be paid by credit card and divided between the physician and a service provider implementing the system of the invention. According to one embodiment, the service provider will attempt to get insurance companies to reimburse for this service. It is to be understood, however, that there is much popular sentiment for second opinions to be covered by insurance companies. For instance, New York and Missouri have laws require that insurance companies in their states cover medical second opinions.[http://www.wibcc.org/the_news.html, Missouri Revised Statutes, Chapter 354, Health Services Corporations—Health Maintenance Organizations—Section 354.207]. Accordingly, it should be understood that having fee schedules based on the standard CPT codes will facilitate third party reimbursement.

In other embodiments, a system according to the invention provides other potential sources of revenue besides direct payments from patients and their insurance carriers. These other revenue sources include advertising and profits shared with potential partners such as internet based medical records companies.

In certain embodiments, a quality assurance board will be formed to randomly review the recommendations of opinion providers. In some ways this would be a second opinion of a second opinion. Review criteria would include clarity, accuracy, and balance. In addition, the primary physician will review the quality of the second opinion using these same criteria. Patients will provide their feedback on the physicians for other consumers to review. In certain embodiment, this feedback will be provided by way of a webpage.

According to certain embodiments, providers within the system will be required to have malpractice insurance. Potential exposure to physicians rendering a second opinion is limited because, in most embodiments, no treatment is actually taking place: No medications are prescribed. No procedures are performed.

In one aspect, patients will be informed that the second opinion service is an educational tool only. Because the second opinion is based on information provided by the patient, it is not intended to be used as medical advice, or as a substitute for treatment by a primary physician. In most embodiments, physicians are precluded from modifying current treatments or beginning new therapies.

Also in most contemplated embodiments, all medical records will be confidential. Patients will be informed on the relative privacy limitations of email and the possibility of employers or co-workers obtaining access to their email. Encryption techniques will be employed when feasible. Patient-physician communication will not be released without the patient's consent. Patient-identifiable information will not be sent to a third party without the patient's express permission. No records will be released without the patients' written permission. All records will conform to the Health Insurance Portability and Accountability Act (HIPAA) that governs all US medical records [http://www.privacyrights.org/fsgs8-med.htm].

While the exemplary embodiments described above have been chosen primarily from the field of medical referral activities, one of skill in the art will appreciate that the principles of the invention are equally well applied, and that the benefits of the present invention are equally well realized in a wide variety of other contexts including, for example, dental practitioner referral systems. Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. An evaluation device comprising:
an automatic digital computer;
a data storage device coupled to said automatic digital computer, said data storage device including a computer readable medium, said computer readable medium being adapted to store a control software program and data profile information;
a user interface device coupled to said automatic digital computer, said user interface device being adapted to receive input information, said input information including a portion of said data profile information, wherein said data profile information includes a first IDC code characterizing a condition of a patient as diagnosed by a first physician and wherein said data profile information further includes a second IDC code, said second IDC code characterizing an area of practice of a second physician and wherein said automatic digital computer is adapted to receive said first and second IDC codes from said data storage device and responsively correlate said second physician to said patient, whereupon said second physician provides said patient a diagnosis for comparison by said patient to a diagnosis of said first physician.
